(19) United States
(12) Patent Application Publication
(10) Pub. No.: US 2026/0010634 A1
(43) Pub. Date: Jan. 8, 2026

(54) Method of Configuring Bios Settings

(71) Applicant: MITAC COMPUTING TECHNOLOGY CORPORATION, Taoyuan City (TW)

(72) Inventor: Feng-Chi Yang, Hsinchu (TW)

(21) Appl. No.: 19/059,487

(22) Filed: Feb. 21, 2025

(30) Foreign Application Priority Data
Jul. 2, 2024 (TW) 113124704

(51) Int. Cl. G06F 21/57; G06F 9/445; G06K 19/06

(52) U.S. Cl. CPC G06F 21/575; G06F 9/44505; G06K 19/06028; G06F 2221/034

(57) ABSTRACT

A method includes obtaining an asserted SKU code; determining whether the asserted SKU code matches a reference SKU code; when the asserted SKU code does not match the reference SKU code, modifying a comparison flag to indicate an inconsistent state; selecting a public key corresponding to one of ordinary SKU codes that matches the asserted SKU code; obtaining an OS image; performing a secure boot verification to verify the OS image based on the public key and a private key contained in the OS image; when the OS image is successfully verified, determining whether the comparison flag indicates the inconsistent state; when the comparison flag indicates the inconsistent state, replacing the reference SKU code with the asserted SKU code; selecting a BIOS configuration data set corresponding to one of the ordinary SKU codes that matches the asserted SKU code; and configuring the BIOS settings with the BIOS configuration data set.

### CROSS-REFERENCE TO RELATED APPLICATION

This application claims priority to Taiwanese Patent Application No. 113124704 filed Jul. 2, 2024, the disclosure of which is hereby incorporated by reference in its entirety.

### BACKGROUND OF THE DISCLOSURE

### Field of the Disclosure

The disclosure relates to a method of configuring Basic Input/Output System (BIOS) settings for a specific model of computer.

### Description of Related Art

It is usually necessary to configure Basic Input/Output System (BIOS) settings in a specific way for each computer model manufactured by each manufacturer. This procedure of configuring BIOS settings complicates the manufacturing process of computers and is prone to mistakes.

In addition, an ordinary BIOS firmware (i.e., one that is not specifically configured for a specific computer model) is often designed for use with various computer manufacturers and with various computer models. Thus, the ordinary BIOS firmware would contain manufacturer information that is related to the computer manufacturers, e.g., logos of the computer manufacturers, names of the computer manufacturers, names of computer products, customized functions for BIOS, and so on. Unauthorized exposure, either intentional or unintentional, of the manufacturer information may occur during the process of configuring BIOS settings.

### SUMMARY OF THE DISCLOSURE

Therefore, an object of the disclosure is to provide a method of configuring Basic Input/Output System (BIOS) settings for a specific model of computer that can alleviate at least one of the drawbacks of the prior art.

According to the disclosure, the computer of the specific model includes a processor and a non-volatile random-access memory (NVRAM) device that are electrically connected to each other. The NVRAM device stores BIOS firmware, a plurality of BIOS configuration data sets that correspond respectively to a plurality of ordinary stock-keeping-unit (SKU) codes, and a plurality of public keys that correspond respectively to the ordinary SKU codes. The method is to be implemented by the processor, and includes steps of:
obtaining an asserted SKU code that corresponds to the specific model of computer;
determining whether the asserted SKU code conforms with a reference SKU code;
in response to determining that the asserted SKU code does not conform with the reference SKU code, modifying a comparison flag to indicate an inconsistent state;
selecting, from among the plurality of public keys stored in the NVRAM device, a public key that corresponds to one of the plurality of ordinary SKU codes which conforms with the asserted SKU code;
obtaining an operating system (OS) image, the OS image containing a private key;
performing a secure boot verification to verify the OS image based on the private key contained in the OS image and the public key thus selected;
in response to successfully verifying the OS image, determining whether the comparison flag indicates the inconsistent state;
in response to determining that the comparison flag indicates the inconsistent state, replacing the reference SKU code with the asserted SKU code;
selecting, from among the plurality of BIOS configuration data sets stored in the NVRAM device, a BIOS configuration data set that corresponds to one of the ordinary SKU codes which conforms with the asserted SKU code; and
configuring the BIOS settings for the BIOS firmware stored in the NVRAM device with the BIOS configuration data set thus selected.

### BRIEF DESCRIPTION OF THE DRAWINGS

The terms FIG., FIGS., Figure, and Figures are used interchangeably in the specification to refer to the corresponding figures in the drawings.

Other features and advantages of the disclosure will become apparent in the following detailed description of the embodiment(s) with reference to the accompanying drawings. It is noted that various features may not be drawn to scale.

FIG. 1 is a block diagram illustrating a computer of a specific model according to an embodiment of the disclosure.

FIGS. 2 and 3 are flow charts cooperatively illustrating a method of configuring Basic Input/Output System (BIOS) settings for the specific model of computer according to an embodiment of the disclosure.

### DESCRIPTION OF NON-LIMITING EMBODIMENTS OF THE DISCLOSURE

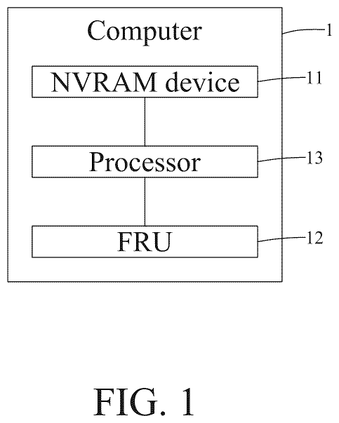

Referring to FIG. 1, an embodiment of a computer 1 of a specific model according to the disclosure is illustrated. The computer 1 includes a field replace unit (FRU) 12, a non-volatile random-access memory (NVRAM) device 11, and a processor 13 that is electrically connected to the FRU 12 and the NVRAM device 11.

The processor 13 of the disclosure may be implemented by a central processing unit (CPU), a microprocessor, a micro control unit (MCU), a system on a chip (SoC), or any circuit configurable/programmable in a software manner and/or hardware manner to implement relevant functionalities as will be discussed in this disclosure.

The NVRAM device 11 stores Basic Input/Output System (BIOS) firmware, a plurality of BIOS configuration data sets that correspond respectively to a plurality of ordinary stock-keeping-unit (SKU) codes, and a plurality of public keys that correspond respectively to the ordinary SKU codes. Moreover, the NVRAM device 11 is configured to be used to store a reference SKU code. The NVRAM device 11 of the disclosure may be implemented by flash memory, read only memory (ROM), programmable ROM (PROM), electrically-erasable programmable read-only memory (EEPROM), a solid state disk (SSD), or the like, but is not limited to the disclosure herein.

The FRU 12 is configured to be used to store an asserted SKU code. The FRU 12 of the disclosure may be implemented to include random access memory (RAM), double data rate synchronous dynamic random access memory (DDR SDRAM), ROM, PROM, flash memory, a hard disk drive (HDD), a solid state disk (SSD), EEPROM or any other volatile/non-volatile memory devices, but is not limited thereto.

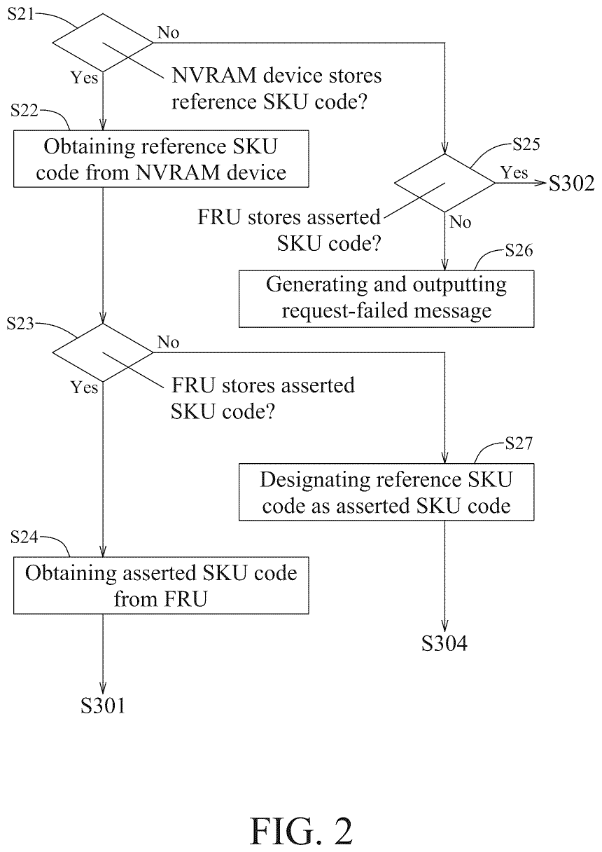

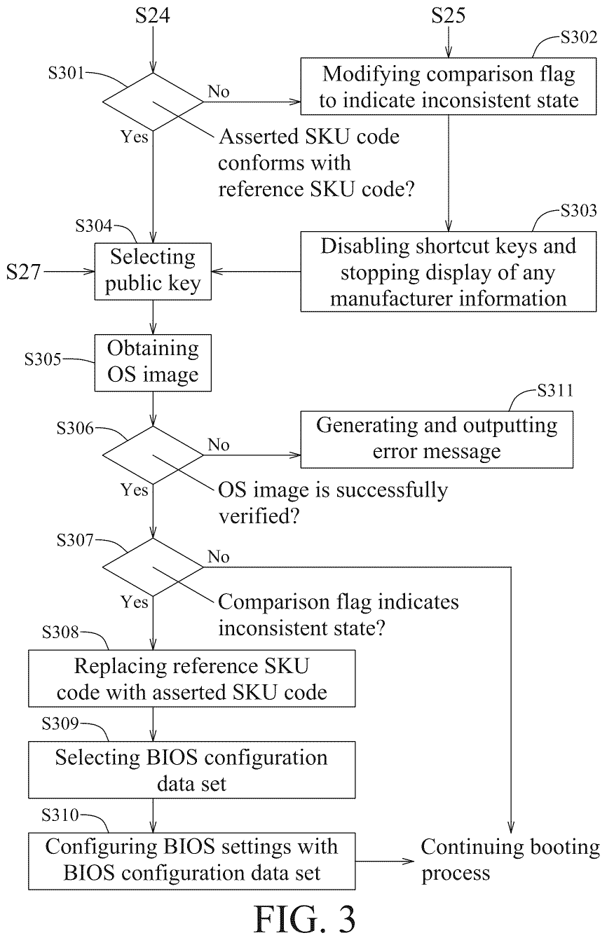

Referring to FIGS. 2 and 3, an embodiment of a method of configuring BIOS settings for a specific model of computer according to the disclosure is illustrated. The method is to be implemented by the processor 13 of the computer 1 that is previously described. The method includes a preparatory procedure and a configuration procedure.

The preparatory procedure includes steps S21 to S27 shown in FIG. 2 and delineated below.

In step S21, the processor 13 determines whether the NVRAM device 11 stores the reference SKU code. In response to determining that the NVRAM device 11 stores the reference SKU code, a procedure flow of the method proceeds to step S22. On the other hand, in response to determining that the NVRAM device 11 does not store the reference SKU code, the procedure flow proceeds to step S25.

It is worth noting that when the BIOS settings have not yet been specifically configured for the specific model of computer at all, i.e., the BIOS settings remain as factory settings (which are often set in advance by a motherboard manufacturer), the NVRAM device 11 would not store the reference SKU code, or would store a preset code by default. The NVRAM device 11 would store the reference SKU code rather than the preset code only after the BIOS settings have been specifically configured for the specific model of computer (at this moment, the BIOS settings are usually not kept to be factory settings). In other words, when the BIOS settings are specifically configured for the specific model of computer, factory settings are usually removed/replaced.

In step S22, the processor 13 obtains the reference SKU code from the NVRAM device 11.

In step S23, the processor 13 determines whether the FRU 12 stores the asserted SKU code. In response to determining that the FRU 12 stores the asserted SKU code, the procedure flow proceeds to step S24. Contrarily, in response to determining that the FRU 12 does not store the asserted SKU code, the procedure flow proceeds to step S27.

It is worth noting that sometimes, the asserted SKU code stored in the FRU 12 may have an incorrect format, which would make the asserted SKU code invalid. That is to say, when the asserted SKU code stored in the FRU 12 has an incorrect format, the processor 13 would determine that the FRU 12 does not store the asserted SKU code. Consequently, the processor 13 determines that the FRU 12 stores the asserted SKU code only under the premise that the asserted SKU code stored in the FRU 12 has a correct format.

In step S24, the processor 13 obtains the asserted SKU code from the FRU 12. When the processor 13 has obtained both the asserted SKU code and the reference SKU code, the procedure flow proceeds to step S301 in the configuration procedure shown in FIG. 3.

In step S25, which occurs after it is determined in step S21 that the NVRAM device 11 does not store the reference SKU code, the processor 13 determines whether the FRU 12 stores the asserted SKU code. In response to determining that the FRU 12 stores the asserted SKU code, the processor 13 obtains the asserted SKU code from the FRU 12, and then the procedure flow proceeds to step S302 in the configuration procedure shown in FIG. 3. Otherwise, in response to determining that the FRU 12 does not store the asserted SKU code, the procedure flow proceeds to step S26.

In step S26, the processor 13 generates and outputs a request-failed message so as to indicate a failure to obtain the reference SKU code from the NVRAM device 11 and a failure to obtain the asserted SKU code from the FRU 12. Then, an operator who is to configure the BIOS settings (e.g., a computer manufacturer) may press any key of a keyboard (not shown) of the computer 1 to exit the procedure flow of the method. Alternatively, the operator may try to deal with this situation by making modifications so that the FRU 12 correctly stores the asserted SKU code, and returning the procedure flow back to step S25 for making the abovementioned determination again (not shown).

In step S27, which occurs after it is determined in step S23 that the FRU 12 does not store the asserted SKU code, the processor 13 designates the reference SKU code as the asserted SKU code for the specific model of computer, and then the procedure flow proceeds to step S304 in the configuration procedure shown in FIG. 3.

The configuration procedure includes steps S301 to S311 shown in FIG. 3 and delineated below.

In step S301, the processor 13 determines whether the asserted SKU code conforms with the reference SKU code. In response to determining that the asserted SKU code does not conform with the reference SKU code, the procedure flow proceeds to step S302. Contrarily, in response to determining that the asserted SKU code conforms with the reference SKU code, the procedure flow proceeds to step S304.

In step S302, the processor 13 modifies a comparison flag to indicate an inconsistent state. The comparison flag can indicate the inconsistent state, which signifies that the asserted SKU code does not conform with the reference SKU code, or a consistent state, which signifies that the asserted SKU code conforms with the reference SKU code. The comparison flag indicating the inconsistent state means that the reference SKU code has to be updated (e.g., to be replaced by the asserted SKU code). It is worth noting that the comparison flag indicates the consistent state by default.

In step S303, the processor 13 disables at least one or more shortcut keys for the BIOS firmware, and stops displaying via a display (not shown) of the computer any manufacturer information that is related to computer manufacturers (such as logos of the computer manufacturers, names of the computer manufacturers, names of computer products, and so on). This step is implemented to ensure that the BIOS settings are configured by a qualified operator (e.g., the manufacturer of computers of the specific computer model, or a manufacturer who is authorized or entrusted to configure the BIOS settings) for system safety of the computer 1. In other words, the comparison flag indicating the consistent state implies a high possibility that the BIOS settings are being configured by the qualified operator, so said at least one or more shortcut keys is allowed to be used by the qualified operator, and the manufacturer information is allowed to be displayed to the qualified operator. On the other hand, the comparison flag indicating the inconsistent state may imply that the BIOS settings are being configured by a non-qualified operator, so said at least one or more shortcut keys are disabled to prevent the BIOS settings from being modified by the non-qualified operator, and displaying of the manufacturer information is stopped to prevent unauthorized exposure of the manufacturer information to the non-qualified operator.

In step S304, the processor 13 selects, from among the public keys stored in the NVRAM device 11, a public key that corresponds to one of the plurality of ordinary SKU codes which conforms with the asserted SKU code.

In step S305, the processor 13 obtains an operating system (OS) image via a universal serial bus (USB) interface. Since the USB interface has been well known to one skilled in the relevant art, detailed explanation of the same is omitted herein for the sake of brevity.

In step S306, the processor 13 performs a secure boot verification to verify the OS image based on a private key contained in the OS image and the public key selected in step S304. In particular, the secure boot verification is performed by using a digital signature scheme. Then, the processor 13 determines whether the OS image is successfully verified. In response to successfully verifying the OS image, the procedure flow proceeds to step S307. Otherwise, in response to a failure in verifying the OS image, the procedure flow proceeds to step S311. Since implementations of the secure boot verification and the digital signature scheme are well known to one skilled in the relevant art, detailed explanations of the same are omitted herein for the sake of brevity.

It is worth noting that conventionally, the secure boot verification is utilized to check whether or not the OS image is trusted to be used for starting up a computer. In this embodiment, the secure boot verification is utilized to determine whether the operator is qualified, i.e., whether or not the operator is the manufacturer of computers of the specific computer model, or a manufacturer who is authorized or entrusted to configure the BIOS settings. It should be noted that only the qualified operator owns an OS image containing a private key that can be utilized in cooperation with a public key for the computer to successfully pass the secure boot verification (hereinafter also referred to as the qualified OS image). Therefore, an operator who does not own the qualified OS image would fail to pass the secure boot verification (which means that such an operator may not be the qualified operator) and is unable to configure the BIOS settings; only the qualified operator that has the qualified OS image can successfully configure the BIOS settings for the specific computer model by first successfully passing the secure boot verification. In this way, issues of data breach, either intentional or unintentional, such as unauthorized exposure of manufacturer information contained in BIOS firmware of computers may be alleviated.

The abovementioned way of utilizing the secure boot verification is a new use of the secure boot verification, which saves time and effort spent for developing a new approach of verification. Moreover, software programs related to the secure boot verification have been widely installed in most computers nowadays, and thus implementing the method according to the disclosure is convenient and suitable to most computers.

In step S307, the processor 13 determines whether the comparison flag indicates the inconsistent state. In response to determining that the comparison flag indicates the inconsistent state, the procedure flow proceeds to step S308. On the other hand, in response to determining that the comparison flag does not indicate the inconsistent state, the processor 13 continues a booting process of the computer 1.

In step S308, the processor 13 replaces the reference SKU code stored in the NVRAM device 11 with the asserted SKU code.

In step S309, the processor 13 selects, from among the plurality of BIOS configuration data sets stored in the NVRAM device 11, a BIOS configuration data set that corresponds to one of the ordinary SKU codes which conforms with the asserted SKU code.

In step S310, the processor 13 configures the BIOS settings for the BIOS firmware stored in the NVRAM device 11 with the BIOS configuration data set thus selected. Herein, the BIOS settings would be successfully configured. Thereafter, the processor 13 continues the booting process of the computer 1.

In step S311, which occurs after it is determined in step S306 that the OS image fails to be verified, the processor 13 generates and outputs an error message to indicate a failure of verifying the OS image. Then, the operator may press any key of the keyboard to exit the procedure flow of the method. Alternatively, the operator may replace the OS image with another OS image, and make the procedure flow of the method return back to step S306 for performing the secure boot verification to verify the another OS image (not shown).

To sum up, the method of configuring BIOS settings for a specific computer model according to the disclosure involves a step of performing the secure boot verification to verify an OS image prepared by an operator who is to configure the BIOS settings (e.g., a manufacturer of computers of the specific computer model) based on a private key contained in the OS image and a public key selected according to an asserted SKU code prepared by the operator for the specific computer model, so as to determine whether the operator is qualified. It should be noted that only a qualified operator (i.e., the manufacturer of computers of the specific computer model, or a manufacturer who is authorized or entrusted to configure the BIOS settings) owns an OS image containing a private key that can be utilized in cooperation with a public key for the computer to successfully pass the secure boot verification. Therefore, only the qualified operator can successfully configure the BIOS settings for the specific computer model. In this way, issues of data breach, such as unauthorized exposure of manufacturer information contained in BIOS firmware of computers, in either an intentional way or an unintentional way, may be alleviated.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method of configuring Basic Input/Output System (BIOS) settings for a specific model of computer, a computer of the specific model comprising a processor and a non-volatile random-access memory (NVRAM) device that are electrically connected to each other, the NVRAM device storing BIOS firmware, a plurality of BIOS configuration data sets that correspond respectively to a plurality of ordinary stock-keeping-unit (SKU) codes, and a plurality of public keys that correspond respectively to the ordinary SKU codes, the method being implemented by the processor and comprising steps of:
obtaining an asserted SKU code that corresponds to the specific model of computer;
determining whether the asserted SKU code conforms with a reference SKU code;
in response to determining that the asserted SKU code does not conform with the reference SKU code, modifying a comparison flag to indicate an inconsistent state;
selecting, from among the plurality of public keys stored in the NVRAM device, a public key that corresponds to one of the plurality of ordinary SKU codes which conforms with the asserted SKU code;
obtaining an operating system (OS) image, the OS image containing a private key;
performing a secure boot verification to verify the OS image based on the private key contained in the OS image and the public key thus selected;
in response to successfully verifying the OS image, determining whether the comparison flag indicates the inconsistent state;
in response to determining that the comparison flag indicates the inconsistent state, replacing the reference SKU code with the asserted SKU code;
selecting, from among the plurality of BIOS configuration data sets stored in the NVRAM device, a BIOS configuration data set that corresponds to one of the ordinary SKU codes which conforms with the asserted SKU code; and
configuring the BIOS settings for the BIOS firmware stored in the NVRAM device with the BIOS configuration data set thus selected.

2. The method as claimed in claim 1, further comprising a step of, in response to determining that the asserted SKU code does not conform with the reference SKU code:
disabling at least one shortcut key for the BIOS firmware, and stopping display of any manufacturer information that is related to computer manufacturers.

3. The method as claimed in claim 1, wherein selecting a public key from among the plurality of public keys is implemented in response to determining that the asserted SKU code conforms with the reference SKU code.

4. The method as claimed in claim 1, further comprising steps of, prior to obtaining an asserted SKU code:
determining whether the NVRAM device stores the reference SKU code; and
in response to determining that the NVRAM device stores the reference SKU code, obtaining the reference SKU code from the NVRAM device.

5. The method as claimed in claim 4, the computer of the specific model further comprising a field replace unit (FRU) that is electrically connected to the processor, the method further comprising steps of, subsequent to obtaining the reference SKU code:
determining whether the FRU stores the asserted SKU code; and
in response to determining that the FRU does not store the asserted SKU code, designating the reference SKU code as the asserted SKU code for the specific model of computer, and implementing the step of selecting a public key from among the plurality of public keys stored in the NVRAM device,
wherein obtaining an asserted SKU code is implemented in response to determining that the FRU stores the asserted SKU code.

6. The method as claimed in claim 5, wherein obtaining an asserted SKU code is to obtain the asserted SKU code from the FRU.

7. The method as claimed in claim 4, the computer of the specific model further comprising a field replace unit (FRU) that is electrically connected to the processor, the method further comprising steps of:
in response to determining that the NVRAM device does not store the reference SKU code, determining whether the FRU stores the asserted SKU code; and
in response to determining that the FRU stores the asserted SKU code, modifying the comparison flag to indicate the inconsistent state,
wherein selecting a public key from among the plurality of public keys stored in the NVRAM device is implemented in response to determining that the FRU stores the asserted SKU code.

8. The method as claimed in claim 7, further comprising steps of, in response to determining that the FRU stores the asserted SKU code:
disabling at least one shortcut key for the BIOS firmware; and
stopping display of any manufacturer information that is related to computer manufacturers.

9. The method as claimed in claim 7, further comprising a step of:
generating and outputting a request-failed message in response to determining that the NVRAM device does not store the reference SKU code and that the FRU does not store the asserted SKU code.

10. The method as claimed in claim 1, wherein obtaining an OS image is to obtain the OS image via a universal serial bus (USB) interface.

11. The method as claimed in claim 1, wherein performing a secure boot verification is to perform the secure boot verification by using a digital signature scheme.

12. The method as claimed in claim 1, wherein performing a secure boot verification is to determine whether an operator who is to configure the BIOS settings is qualified.

13. The method as claimed in claim 12, wherein performing a secure boot verification is to perform the secure boot verification by using a digital signature scheme.

14. The method as claimed in claim 1, further comprising a step of generating and outputting an error message in response to a failure in verifying the OS image.

15. The method as claimed in claim 1, further comprising a step of:
continuing a booting process in response to determining that the comparison flag does not indicate the inconsistent state.

16. The method as claimed in claim 1, further comprising a step of continuing a booting process subsequent to configuring the BIOS settings with the BIOS configuration data set.
